(19) United States
(12) Patent Application Publication
(10) Pub. No.: US 2004/0147680 A1
(43) Pub. Date: Jul. 29, 2004

(54) Powder molding material and process for producing the same

(75) Inventor: Hiroyuki Sugimoto, Funabashi-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/705,855

(22) Filed: Nov. 13, 2003

(30) Foreign Application Priority Data
Jan. 29, 2003 (JP) 2003-019918

(51) Int. Cl. C08L 23/00

(52) U.S. Cl. 525/240

(57) ABSTRACT

There are provided:

(I) a powder molding material comprising powder, which powder (1) contains a polymer particle, and (2) satisfies the following requirements (i) and (ii), wherein the polymer particle \mathring{1} comprises a thermoplastic resin and/or thermoplastic elastomer, and \mathring{/2} has a melt flow rate of not less than 10 g/10 minutes measured at 230° C. under a load of 21.18 N according to JIS K-7210 (1976):

(i) the powder has an average particle diameter of from 200 to 350 μm, and

(ii) a content of powder having a particle diameter of not more than 150 μm contained in the powder is not more than 25% by weight, wherein a total of the powder is 100% by weight, and

(II) a process for producing the above-mentioned powder molding material.

### FIELD OF THE INVENTION

The present invention relates to a powder molding material having a superior melting property, powder flowability and workability, and a process for producing the powder molding material.

### BACKGROUND OF THE INVENTION

A skin material such as an automobile interior part is required to have (1) a complicated uneven pattern on its surface such as a leather-like embossed pattern and a stitch pattern, and (2) a complicated design such as a visor part of an instrumental panel. As said skin material, a powder molded article is mainly used. An example of powder known in the art used for molding such a powder molded article is that obtained by mechanically pulverizing a pellet, for example, freeze-pulverizing a pellet, which pellet comprises a thermoplastic resin and/or thermoplastic elastomer (for example, JP 5-5050A and JP 2002-166498A).

Although the above-mentioned conventional powder has a superior melting property and powder flowability, powder having a small diameter contained in said powder may be scattered in a working environment (i) when adding said powder to a powder box of a powder molding machine, or (ii) in a powder molding process, and therefore, said powder does not have enough satisfactory workability.

### SUMMARY OF THE INVENTION

Under these circumstances, an object of the present invention is to provide a powder molding material having a superior melting property, powder flowability and workability. Another object of the present invention is to provide a process for producing said powder molding material.

The present invention is a powder molding material comprising powder, which powder (1) contains a polymer particle, and (2) satisfies the following requirements (i) and (ii), wherein the polymer particle \mathring{1} comprises a thermoplastic resin and/or thermoplastic elastomer, and \mathring{2} has a melt flow rate of not less than 10 g/10 minutes measured at 230° C. under a load of 21.18 N according to JIS K-7210 (1976):

(i) the powder has an average particle diameter of from 200 to 350 μm, and

(ii) a content of powder having a particle diameter of not more than 150 μm contained in the powder is not more than 25% by weight, wherein a total of the powder is 100% by weight.

The present invention is also a process for producing the above-mentioned powder molding material, which comprises the steps of:

(1) cooling a pellet containing a thermoplastic resin and/or thermoplastic elastomer at temperature of not higher than a glass transition temperature thereof, and

(2) pulverizing the cooled pellet in a mill having an inner temperature of from −72 to −88° C.

In the present invention, the term “powder molding material” means a material used for powder molding.

### DETAILED DESCRIPTION OF THE INVENTION

Examples of the thermoplastic resin in the present invention are the below-mentioned polyolefin-based resin, an ABS resin (acrylonitrile-butadiene-styrene copolymer resin) and polystyrene.

Examples of the thermoplastic elastomer in the present invention are an olefin-based thermoplastic elastomer, a styrene-based thermoplastic elastomer, a polyurethane-based thermoplastic elastomer, a polyvinyl chloride-based thermoplastic elastomer and a polyamide-based thermoplastic elastomer (see, for example, “Thermoplastic Elastomer Composition” written by Shoji Matsuzaki, and published by Kagaku Kogyo Nippo in 1991).

Each of the above-mentioned thermoplastic resin and thermoplastic elastomer is used singly or in combination of at least two thereof. Among them, a thermoplastic elastomer is preferable in order to obtain a powder molded article having superior flexibility and mold releasability.

An example of the above-mentioned olefin-based thermoplastic elastomer is a composition comprising a polyolefin-based resin and a polyolefin-based rubber. Said olefin-based thermoplastic elastomer can be produced by a method disclosed in, for example, JP 5-5050A, JP 10-30036A, JP 10-231392A or JP 2001-49052A.

The above-mentioned polyolefin-based resin means a polymer (i) containing at least one polymerization unit of an olefin (hereinafter, “polymerization unit of a monomer” such as “polymerization unit of an olefin” is referred to simply as “monomer unit” such as “olefin unit”) selected from olefins having from 2 to 10 carbon atoms such as ethylene, propylene, 1-butene and 1-hexene in a content of not less than 50% by weight, and (ii) having an A hardness of more than 98 measured according to JIS K-6253 (1997). Said polyolefin-based resin may contain other monomer unit, and examples of said other monomer are conjugated dienes having from 4 to 8 carbon atoms such as 1,3-butadiene, 2-methyl-1,3-butadiene (isoprene), 1,3-pentadiene and 2,3-dimethyl-1,3-butadiene; non-conjugated dienes having from 5 to 15 carbon atoms such as dicyclopentadiene, 5-ethylidene-2-norbornene, 1,4-hexadiene, 1,5-dicyclooctadiene, 7-methyl-1,6-octadiene and 5-vinyl-2-norbornene; vinylester compounds such as vinyl acetate; unsaturated carboxylic acid esters such as methyl acrylate, ethyl acrylate, butyl acrylate, methyl methacrylate and ethyl methacrylate; and unsaturated carboxylic acids such as acrylic acid and methacrylic acid.

Examples of the polyolefin-based resin are an ethylene homopolymer, a propylene homopolymer, a 1-butene homopolymer, an ethylene-propylene copolymer, an ethylene-1-butene copolymer, an ethylene-1-hexene copolymer, an ethylene-1-octene copolymer, a propylene-1-butene copolymer, a propylene-1-hexene copolymer, a propylene-1-octene copolymer, an ethylene-propylene-1-butene copolymer, an ethylene-propylene-1-hexene copolymer and an ethylene-propylene-1-octene copolymer. These polyolefin-based resins may be used singly, respectively, or in combination of at least two thereof. Among them, preferable is a polypropylene-based resin having a propylene unit content of not less than 80% by weight, more preferably not less than 90% by weight, and further preferably not less than 95% by weight in order to improve heat resistance of the obtained powder molded article.

A melt flow rate (MFR) of the polyolefin-based resin measured at 230° C. under a load of 21.18 N according to JISK-7210 (1976) is preferably from 10 to 500 g/10 minutes, more preferably from 50 to 400 g/10 minutes, and further preferably from 100 to 300 g/10 minutes in order to further improve (1) a melting property of the powder molding material, and (2) mechanical strength and abrasion resistance of the obtained powder molded article.

The above-mentioned polyolefin-based rubber means a polymer (i) containing at least one polymerization unit of an olefin selected from olefins having from 2 to 10 carbon atoms such as ethylene, propylene, 1-butene, 2-methylpropylene, 3-methyl-1-butene and 1-hexene in a content of not less than 50% by weight, and (ii) having an A hardness of not more than 98 measured according to JISK-6253 (1997). Said polyolefin-based rubber may contain other monomer unit, and examples of said other monomer are conjugated dienes having from 4 to 8 carbon atoms such as 1,3-butadiene, 2-methyl-1,3-butadiene (isoprene), 1,3-pentadiene and 2,3-dimethyl-1,3-butadiene; non-conjugated dienes having from 5 to 15 carbon atoms such as dicyclopentadiene, 5-ethylidene-2-norbornene, 1,4-hexadiene, 1,5-dicyclooctadiene, 7-methyl-1,6-octadiene and 5-vinyl-2-norbornene; vinylester compounds such as vinyl acetate; unsaturated carboxylic acid esters such as methyl acrylate, ethyl acrylate, butyl acrylate, methyl methacrylate and ethyl methacrylate; and unsaturated carboxylic acids such as acrylic acid and methacrylic acid.

Examples of the polyolefin-based rubber are a propylene homopolymer, a 1-butene homopolymer, 2-methylpropene homopolymer, an ethylene-propylene copolymer, an ethylene-1-butene copolymer, an ethylene-3-methyl-1-butene copolymer, an ethylene-1-hexene copolymer, an ethylene-1-octene copolymer, a propylene-1-butene copolymer, a propylene-1-hexene copolymer, a propylene-1-octene copolymer, an ethylene-propylene-5-ethylidene-2-norbornene copolymer, an ethylene-propylene-1-butene copolymer, an ethylene-propylene-1-hexene copolymer and an ethylene-propylene-1-octene copolymer. These polyolefin-based rubbers may be used singly, respectively, or in combination of at least two thereof. These polyolefin-based rubbers can be produced by a method known in the art.

Among them, an ethylene-α-olefin copolymer is preferable in order to improve mechanical strength of the obtained powder molded article. A preferable α-olefin is propylene, 1-butene, 1-hexene or 1-octene in view of availability.

Among the polyolefin-based rubbers, preferable is an ethylene-α-olef in copolymer having an A hardness of not more than 80 measured according to JISK-6253 (1997) in order to improve flexibility, mechanical strength and low temperature impact resistance of the obtained powder molded article (requirement (iii)).

A melt flow rate (MFR) of the polyolefin-based rubber measured at 190° C. under a load of 21.18 N according to JIS K-7210 (1976) is preferably from 0.5 to 50 g/10 minutes, and more preferably from 1 to 30 g/10 minutes in order to further improve (1) a melting property of the powder molding material, and (2) mechanical strength and abrasion resistance of the obtained powder molded article.

A content of the polyolefin-based resin and polyolefin-based rubber contained in the olefin-based thermoplastic elastomer is generally from 20 to 300 parts by weight, and preferably from 25 to 150 parts by weight, respectively, per 100 parts by weight of the polyolefin-based resin in order to improve flexibility, heat resistance and low temperature impact resistance of the obtained powder molded article.

When the polymer particle contains the olefin-based thermoplastic elastomer, it is possible to further improve mechanical strength of a powder molded article by combining a hydrogenated conjugated diene polymer therewith. Examples of the hydrogenated conjugated diene polymer are a hydrogenated product of a polymer of at least one conjugated diene having from 4 to 8 carbon atoms such as 1,3-butadiene, isoprene, pentadiene and 2,3-dimethylbutadiene; a hydrogenated product of polybutadiene; and a hydrogenated product of polyisoprene. While an unsaturated bond contained in a conjugated diene unit is saturated by hydrogenation to result in a hydrogenated conjugated diene unit, preferable is a hydrogenated conjugated diene polymer having a hydrogenated conjugated diene unit, which unit has a two or more carbon atom-carrying branched chain, in a content of more than 50% by weight in order to improve flexibility of the obtained powder molded article, wherein a content of the hydrogenated conjugated diene unit contained in the hydrogenated conjugated diene polymer is 100% by weight. A hydrogenated conjugated diene polymer may be composed of two or more blocks, which are different from each other in said proportion. Examples of said hydrogenated conjugated diene polymer are that disclosed in JP 3-74409A, and a commercially available one such as DYNARON CEBC 6200 manufactured by JSR Corporation.

When the polymer particle contains a hydrogenated conjugated diene polymer, a content thereof is preferably from 1 to 20% by weight, and more preferably from 2 to 10% by weight per 100% by weight of the olefin-based thermoplastic elastomer in order to improve tensile strength and flexibility of the obtained powder molded article.

When the polymer particle contains the olefin-based thermoplastic elastomer, it is preferable that said olefin-based thermoplastic elastomer contains a silicon compound having a siloxane bond in its molecule in order to improve abrasion resistance of the obtained powder molded article. Said silicon compound may be modified by, for example, acryl, epoxy, carboxylic acid amine or urethane.

When the olefin-based thermoplastic elastomer contains a silicon compound, a content thereof is generally from 0.1 to 10 parts by weight, preferably from 0.3 to 7 parts by weight, and more preferably from 0.5 to 5 parts by weight per 100 parts by weight of the olef in-based thermoplastic elastomer in order to improve (1) a melting property of the powder molding material, and (2) mechanical strength of the obtained powder molded article.

The above-mentioned styrene-based thermoplastic elastomer means a vinyl aromatic compound-conjugated diene copolymer or its hydrogenated product.

An example of the vinyl aromatic compound used for the styrene-based thermoplastic elastomer is that having from 8 to 12 carbon atoms. Said vinyl aromatic compound may have a substituent group such as an alkyl group, for example a methyl group, at a 1-position or 2-position of a vinyl group contained therein. Specific examples of the vinyl aromatic compound are styrene, p-methyl styrene and α-methyl styrene, and these are used singly, respectively, or in combination of two or more thereof. Among them, styrene is preferable in order to further improve mechanical strength of the obtained powder molded article.

An example of the conjugated diene used for the styrene-based thermoplastic elastomer is that having from 4 to 8 carbon atoms, and specific examples thereof are 1,3-butadiene, isoprene, pentadiene and 2,3-dimethylbutadiene. These are used singly, respectively, or in combination of two or more thereof. Among them, 1,3-butadiene and/or isoprene is preferable in order to further improve mechanical strength of the obtained powder molded article.

Examples of the vinyl aromatic compound-conjugated diene copolymer are a styrene-1,3-butadiene copolymer and a styrene-isoprene copolymer, and these are used singly, respectively, or in combination of two or more thereof. These copolymers can be produced by a method known in the art.

The vinyl aromatic compound-conjugated diene copolymer may comprise a block having one kind of a structure or at least two kinds of structures. An example of said copolymer, which comprises a block having one kind of a structure, is that containing a structure wherein a vinyl aromatic compound and a conjugated diene are randomly arranged, such as a styrene-butadiene random copolymer and a styrene-isoprene random copolymer. Examples of said copolymer, which comprises a block having at least two kinds of structures, are a copolymer composed of a styrene homopolymer block-butadiene homopolymer block; a copolymer composed of a styrene homopolymer block-isoprene homopolymer block; a copolymer composed of a styrene homopolymer block-butadiene homopolymer block-styrene homopolymer block; a copolymer composed of a styrene homopolymer block-isoprene homopolymer block-styrene homopolymer block; a copolymer composed of a styrene homopolymer block-butadiene-isoprene copolymer block-styrene homopolymer block; and a copolymer composed of a styrene homopolymer block-styrene-butadiene copolymer block-styrene homopolymer block. The styrene-butadiene copolymer block contained in said styrene homopolymer block-styrene-butadiene copolymer block-styrene homopolymer block may be a block having a structure wherein styrene and butadiene are randomly copolymerized, or a block having a taper-like structure wherein a styrene unit content decreases or increases gradually in said block.

The above-mentioned hydrogenated product of the vinyl aromatic compound-conjugated diene copolymer is a copolymer obtained by hydrogenating the above-mentioned vinyl aromatic compound-conjugated diene copolymer. Said hydrogenated product, namely, a hydrogenated vinyl aromatic compound-conjugated diene copolymer, may be composed of a block having one kind of a structure, or a block having at least two kinds of structures, similarly to that mentioned above in the case of the vinyl aromatic compound-conjugated diene copolymer. Examples of the hydrogenated vinyl aromatic compound-conjugated diene copolymer are a hydrogenated product of a styrene-1,3-butadiene copolymer and that of a styrene-isoprene copolymer, and these are used singly, respectively, or in combination of two or more thereof.

A melt flow rate (MFR) of the styrene-based thermoplastic elastomer measured at 230° C. under a load of 21.18 N according to JIS K-7210 is preferably from 1 to 200 g/10 minutes, more preferably from 2 to 100 g/10 minutes, and further preferably from 3 to 80 g/10 minutes in order to further improve (1) mechanical strength and abrasion resistance of the obtained powder molded article, and (2) a melting property of the obtained powder molding material.

The styrene-based thermoplastic elastomer may be modified by a functional group. Examples of the functional group are one or more groups selected from the group consisting of an acid anhydride group, a carboxyl group, a hydroxyl group, an amino group, an isocyanate group and an epoxy group. When using a styrene-based thermoplastic elastomer modified by said functional group(s), it is possible to improve, for example, adhesiveness between a polyurethane foamed layer and a powder molded article comprising said modified styrene-based thermoplastic elastomer, wherein said polyurethane foamed layer and said powder molded article are adhered to each other to produce a two-layer molded article or a multi-layer molded article.

A preferable styrene-based thermoplastic elastomer is a hydrogenated product of a vinyl aromatic compound-conjugated diene copolymer satisfying the following requirement (iv) in order to improve mechanical strength of the obtained powder molded article:

(iv) the hydrogenated product of a vinyl aromatic compound-conjugated diene copolymer contains the following structural units (a) and (b):

(a) a vinyl aromatic compound polymer block, and

(b) at least one kind of a block selected from the group consisting of the following blocks (b1) and (b2):

(b1) a vinyl aromatic compound-conjugated diene copolymer block, and

(b2) a conjugated diene polymer block.

Examples of said hydrogenated product of a vinyl aromatic compound-conjugated diene copolymer satisfying the requirement (iv) are those having a constitution represented by a formula [(a)-(b)]ₙ, [(a)-(b)]ₙ-(a) or [(b)-(a)]ₙ-(b), and more specifically by a formula [(a)-(b1)]ₙ-(a) or [(a)-(b2)]ₙ-(a), wherein n is an integer of 1 or more, and when (a) and (b) are present in plural number, said plural (a) and (b) may be the same or different, respectively.

A preferable hydrogenated product of a vinyl aromatic compound-conjugated diene copolymer satisfying the requirement (iv) is a styrene-diene-based copolymer represented by a formula (a)-(b1)-(a) or (a)-(b2)-(a) in order to improve mechanical strength of the obtained powder molded article. Examples of said hydrogenated product thereof are a hydrogenated product of a polymer composed of a styrene homopolymer block-butadiene-styrene copolymer block-styrene homopolymer block, wherein the butadiene-styrene copolymer block is a random copolymer block or a taper-like block with a styrene unit content increasing gradually therein; a hydrogenated product of a polymer composed of a styrene homopolymer block-butadiene homopolymer block-styrene homopolymer block; a hydrogenated product of a polymer composed of a styrene homopolymer block-isoprene-styrene copolymer block-styrene homopolymer block, wherein the isoprene-styrene copolymer block is a random copolymer block or a taper-like block with a styrene unit content increasing gradually therein; and a hydrogenated product of a polymer composed of a styrene homopolymer block-isoprene homopolymer block-styrene homopolymer block. Among them, a hydrogenated product of a copolymer represented by the formula (a)-(b2)-(a) is more preferable, and a hydrogenated product of a styrene-butadiene-styrene copolymer is particularly preferable.

A total content (hereinafter, referred to as “T % by weight”) of a vinyl aromatic compound unit contained in the styrene-based thermoplastic elastomer is preferably from 10 to 18% by weight (requirement (v)), and more preferably from 12 to 17% by weight in order to improve flexibility of the obtained powder molded article, wherein a content of all monomer units contained in the styrene-based thermoplastic elastomer is 100% by weight. Said content T can be obtained by a ¹H-NMR measurement using a solution of said thermoplastic elastomer in a solvent such as carbon tetrachloride.

A content (hereinafter, referred to as “V % by weight”) of a hydrogenated conjugated diene unit having a two or more carbon atom-carrying branched chain contained in the hydrogenated product of the vinyl aromatic compound-conjugated diene copolymer is preferably more than 60% by weight (requirement (vi)), more preferably from 65 to 85% by weight, and further preferably from 70 to 80% by weight in order to improve flexibility and resistance to whitening on bending of the obtained powder molded article, wherein a content of the hydrogenated conjugated diene unit contained in said hydrogenated product is 100% by weight. Said content V can be obtained by a Morero method using an infrared analysis. Here, the hydrogenated conjugated diene unit means a saturated unit resulted from hydrogenation of an unsaturated bond contained in the conjugated diene unit of the vinyl aromatic compound-conjugated diene copolymer.

In order to improve heat resistance (surface gloss and bleeding resistance) of the obtained powder molded article, it is preferable that the styrene-based thermoplastic elastomer satisfies the following formula (1) (requirement (vii)):

V≦0.375×S+1.25×T+40 (1)

wherein S (% by weight, wherein a content of the vinyl aromatic compound unit contained in said thermoplastic elastomer is 100% by weight) is a content of the vinyl aromatic compound unit contained in the vinyl aromatic compound polymer block (a).

When using a styrene-based thermoplastic elastomer satisfying the requirements (iv) to (vii), there can be obtained a powder molded article having superior mechanical strength, flexibility, resistance to whitening on bending and heat resistance.

A styrene-based thermoplastic elastomer satisfying the requirements (iv) to (vii) can be produced by a method disclosed in, for example, JP 3-72512A, JP 5-271325A, JP 5-271327 and JP 6-287365.

The styrene-based thermoplastic elastomer may be used in combination with a polyolefin-based resin, and a content of said resin is generally not more than 500 parts by weight, and preferably from 50 to 400 per 100 parts by weight of said thermoplastic elastomer.

The above-mentioned polyurethane-based thermoplastic elastomer is a thermoplastic elastomer containing a polyurethane hard segment and a polyol or polyester soft segemnt. Said thermoplastic elastomer is combined with, if necessary, additives such as stabilizers and pigments. An example of powder comprising said thermoplastic elastomer is MELTEX LA manufactured by Sanyo Chemical Industries, Ltd.

The above-mentioned polyvinyl chloride-based thermoplastic elastomer is a thermoplastic elastomer comprising a polyvinyl chloride resin, plasticizers and, if necessary, additives such as stabilizers and pigments. An example of said thermoplastic elastomer is SUMILIT FLX manufactured by Sumitomo Chemical Co., Ltd. Said thermoplastic elastomer may be blended with a polymer such as NBR (acrylonitrile-butadiene copolymer rubber) and EVA (ethylene-vinyl acetate copolymer rubber) to obtain a powder molded article having superior low temperature impact resistance.

The above-mentioned polyamide-based thermoplastic elastomer is a block copolymer containing a crystal and high melting temperature-having polyamide hard segment and a non-crystal and low glass transition temperature-having polyether or polyester soft segment. Said thermoplastic elastomer may be blended with, if necessary, additives such as stabilizers and pigments. Said thermoplastic elastomer is generally classified into two types of a polyetherester type and a polyesteramide type. Said thermoplastic elastomer may be further blended with a polymer such as NBR and EVA to obtain a powder molded article having superior low temperature impact resistance.

In order to improve mechanical strength, resistance to whitening on bending, heat resistance and light resistance of the obtained powder molded article, preferable is a thermoplastic elastomer comprising an olefin-based thermoplastic elastomer and a styrene-based thermoplastic elastomer; and more preferable is a thermoplastic elastomer comprising (1) an olefin-based thermoplastic elastomer, which contains a polyolefin-based resin and a polyolefin-based rubber satisfying the above-mentioned requirement (iii), and (2) a styrene-based thermoplastic elastomer satisfying all the above-mentioned requirements (iv) and (vii).

A content of the polyolefin-based rubber in the above case is preferably from 20 to 200 parts by weight, and more preferably from 25 to 150 parts by weight per 100 parts by weight of the polyolefin-based resin in order to further improve flexibility, low temperature impact resistance, heat resistance and light resistance of the obtained powder molded article. And, a content of the styrene-based thermoplastic elastomer in the above case is preferably from 20 to 300 parts by weight, and more preferably from 25 to 150 parts by weight per 100 parts by weight of the polyolefin-based resin in order to further improve mechanical strength, resistance to whitening on bending, heat resistance and light resistance of the obtained powder molded article.

The polymer particle may be combined with other polymer components than the above-mentioned thermoplastic resin and thermoplastic elastomer, such as a rubbery polymer, for example, a conjugated diene polymer, natural rubber, butyl rubber, chloroprene rubber, epichlorohydrin rubber and acrylic rubber; an ethylene-acrylic acid copolymer; an ethylene-vinyl acetate copolymer and its saponified product; an ethylene-methyl methacrylate copolymer; an ethylene-glycidyl acrylate-vinyl acetate copolymer; and an ethylene-glycidyl methacrylate-vinyl acetate copolymer.

Further, the polymer particle may be combined with additives such as mineral oil-based softening agents; heat stabilizers, for example, phenol-based heat stabilizers, sulfite-based heat stabilizers, phenylalkane-based heat stabilizers, phosphite-based heat stabilizers, amine-based heat stabilizers and amide-based heat stabilizers; weathering stabilizers; antistatic agents; pigments; silicon compounds; metal soap; wax, for example, paraffin-based wax, microcrystalline-based wax and hydrogenated terpene resins; antifungus agents; antimicrobial agents; fillers; and foaming agents.

There can be obtained a powder molded article having a desired color by combining the polymer particle with a pigment. Examples of the pigment are organic pigments such as azo-based pigments, phthalocyanine-based pigments, threne-based pigments and dyeing lakes; and inorganic pigments such as oxide-based pigments (for example, titanium oxide), chromic acid molybdic acid-based pigments, selenium sulfide compounds, ferrocyan compounds and carbon black.

When using the polymer particle comprising a composition, which contains the thermoplastic resin and/or the thermoplastic elastomer and other optional components, said composition can be produced by melt-kneading those components in a kneading apparatus known in the art such as a mono-screw extruder, a double-screw extruder, a kneader and a roll. Here, (1) it is permitted to knead or dynamically crosslink some of those components to obtain a kneaded or crosslinked product, and then melt-knead said product with the remaining components, or (2) the other optional components may be blended in advance with the thermoplastic resin and/or the thermoplastic elastomer, or may be used individually.

A melt flow rate (MFR) of the polymer particle measured at 230° C. under a load of 21.18 N according to JIS K-7210 (1976) is not less than 10 g/10 minutes, and preferably from 30 to 100 g/10 minutes. When said MFR is less than lo g/10 minutes, a melting property of the powder molding material may be poor. When said MFR is more than 100 g/10 minutes, the obtained powder molded article may be poor in its mechanical strength.

The process for producing the powder molding material in accordance with the present invention comprises the steps of (1) cooling a pellet containing a thermoplastic resin and/or thermoplastic elastomer at temperature of not higher than a glass transition temperature of the thermoplastic resin and/or thermoplastic elastomer, and (2) pulverizing the cooled pellet mechanically in a mill having an inner temperature of from −72 to −88° C., and preferably from −74 to −85° C. When said temperature is higher than −72° C., an average particle diameter of the obtained powder molding material may be large, and when said temperature is lower than −88° C., a content of powder having a particle diameter of not more than 150 μm contained in the obtained powder molding material may be large. Said temperature can be controlled automatically generally by adding a coolant such as liquid nitrogen and cooled nitrogen gas into the mill through, for example, a solenoid valve. Incidentally, the glass transition temperature is measured by a differential scanning calorimetry (DSC), and when two or more glass transition temperatures exist, the lowest temperatures thereof is defined as a glass transition temperature of the thermoplastic resin and/or thermoplastic elastomer.

Examples of the above-mentioned mill are a linlex mill a pin mill, a disc mill, a ball mill and a turbo mill.

The above-mentioned linlex mill is a mill comprising (1) a liner having many sharp parts fixed around the outside of the mill, and (2) a plate having plural blades. A shaft of the plate is generally installed at a center of said mill. A pellet is pulverized by an impact given between the blades and the liner. Here, conditions such as a size of said mill, a size of the plate, a rotating speed of the plate and a number of the blade are suitably selected. Examples of said mill are those of LX series manufactured by Hosokawamicron Corporation. Said mill may have a classification mechanism.

The above-mentioned pin mill is a mill having a pair of discs in its inside, on which discs many pins are melt-fixed. A pellet is pulverized between the discs by rotating the discs in different directions from each other, or by rotating one disc and fixing another disc, thereby obtaining powder for powder molding. Here, conditions such as a size of said mill, a size of the discs, a rotating speed of the discs, a number of the pins and a distance between the discs are suitably selected.

The above-mentioned disc mill is a mill having a pair of discs in its inside, which discs have many sharp part (blades). A pellet is pulverized between the discs by rotating the discs in different directions from each other, or by rotating one disc and fixing another disc, thereby obtaining powder for powder molding. Here, conditions such as a size of said mill, a size of the discs, a rotating speed of the discs, a number of the blades and a distance between the discs are suitably selected.

The above-mentioned ball mill is a pulverizing machine having a drum, inside which a material with good abrasion resistance is adhered. A pellet is pulverized by rotation of the drum containing the pellet and balls therein.

A product pulverized with a mill can be classified into a desired particle size. For example, when said product contains a pulverized product having a particle diameter of more than 600 μm in an amount of more than 5% by weight, a melting property of the obtained powder molding material is lowered, and therefore, the obtained powder molded article may have an inconvenience such as a pin hole. In such a case, the above-mentioned product pulverized with a mill can be used after classifying it using, for example, a vibratory screen in order to remove the above-mentioned pulverized product having a particle diameter of more than 600 μm. The removed product having a particle diameter of more than 600 μm can be further pulverized with the above-mentioned mill to obtain re-pulverized product, which can be used for the powder molding material.

The polymer particle in the present invention may be combined with a fine powder in order to obtain a powder molding material having improved powder flowability and superior resistance to adhesion with each other. Said powder molding material can produce a powder molded article having less wormholes and pin holes.

A primary particle diameter of the above-mentioned fine powder is preferably not more than 10 μm, more preferably not more than 5 μm, and further preferably from 5 nm to 5 μm. Said primary particle diameter is a value obtained by a method comprising the steps of (1) taking a photograph of the fine powder with a transmission electron microscopy (TEM), (2) measuring each particle diameter of about 1000 particles optionally selected, and (3) dividing a sum of respective particle diameters by a total number of the selected particles (about 1000).

Examples of said fine powder are inorganic oxides such as alumina, silica, alumina-silica and calcium carbonate, whose surface can be coated with a substance such as dimethylsilicon oil, or can be treated with a group such as trimethylsilyl group; thermoplastic resins such as acryl-based polymers (for example, JP 2001-123019A), polypropylene, polyethylene and polystyrene; thermosetting resins such as polyurethane; vinyl chloride resins for pastes; metal salts of fatty acids; calcium carbonate; and powder pigments, whose color is preferably the same as that of a pigment in case of a combined use with the thermoplastic elastomer, and examples thereof are those mentioned above. Said fine powder is preferably at least one kind of powder selected from the group consisting of inorganic powder, thermoplastic resin powder and thermosetting resin powder.

The above-mentioned fine powder is used singly or in combination of two or more thereof. For example, it is possible to use only an inorganic oxide, or a combination thereof with powder pigment. The fine powder may be a combination of two or more kinds of fine powders having different primary particle diameters from each other. For example, when a combination of fine powder having a primary particle diameter of not more than 300 nm with fine powder having a primary particle diameter of from 300 nm to 10 μm is used, a powder molding material having further superior packing property and resistance to cohesion can be obtained, comparing with those of a powder molding material obtained using either of those fine powders. Examples of a method for producing the fine powder are (1) a method of mechanically pulverizing a substance such as inorganic oxides, metal salts of fatty acids, calcium carbonate, thermoplastic resins and thermosetting resins, and (2) a method of producing fine powder of a resin (for example, thermoplastic resins and thermosetting resins) according to a suspension polymerization method known in the art. A shape of fine powder of a thermoplastic resin obtained by the above-mentioned former method can be changed to a spherical shape by a method comprising the steps of (i) stirring said fine powder in a solvent poor for said thermoplastic resin in the presence of a dispersant and an emulsifier at a temperature not less than a fusion temperature of said thermoplastic resin, and (ii) cooling.

The fine powder is added in amount of generally from 0.1 to 10 parts by weight, and preferably from 0.2 to 8 parts by weight per 100 parts by weight of the polymer particle. When said amount is less than 0.1 part by weight, powder flowability may not be improved sufficiently, and when said amount is more than 10 parts by weight, a melting property of the obtained powder molding material may be lowered.

A method for dry blending the polymer particle and the fine powder is not particularly limited provided that the fine powder is adhered uniformly on the polymer particle. An example of the method is a batch-wise blending method using a blender equipped with a jacket, a high speed rotating type mixer, a nauter mixer or a universal mixer. Said dry blend is carried out generally at room temperature.

Among them, preferable is a mixer having a mixing and agitating blade, and the following equipments (1) and (2) in view of superior productivity (for example, U.S. Pat. No. 4,512,732):

(1) an equipment for feeding the polymer particle and the fine powder to a mixer at predetermined respective rates in order to blend them in a desired blending ratio, and

(2) an equipment for discharging the dry blended product thereof at a predetermined rate.

Although the above-mentioned dry blend is carried out generally at room temperature, it is preferable to protect temperature against rising by setting up a pipe for cooling (generally, water cooling) on a jacket of a mixer in order to improve powder flowability of the obtained powder molding material.

In order to further improve the above-mentioned productivity, it is permitted to feed the polymer particle continuously from an outlet of a mill into a mixer by connecting the mill with the mixer.

Conditions such as a size of the mixer, a shape of the mixing and agitating blades, rotating conditions and feeding rates of the polymer particle and the fine powder to the mixer are suitably selected.

It is also possible to dry blend the polymer particle and the fine powder in a nauter mixer immediately after the polymer particle is discharged from a mill by connecting the mill with the nauter mixer. Said method has the following advantages (1) and (2):

(1) it is possible to (i) charge the powder molding material into a container such as a flexible container, and then (ii) forward the container, because the powder molding material is discharged after a full storage thereof up to a volume of the nauter mixer, and as a result, productivity is superior, and

(2) the powder molding material hardly absorbs moisture when dry blending under heating a jacket of the nauter mixer with hot water, because the powder molding material is heated until its discharge.

An average particle diameter of the powder molding material of the present invention is from 200 to 350 μm, and preferably from 220 to 330 μm. When said average particle diameter is less than 200 μm, workability of the powder molding material may be poor, and when said average particle diameter is more than 350 μm, a melt property thereof may be poor. Said average particle diameter is measured using standard screens defined in JIS Z-8801 (1976) by a method comprising the steps of:

(1) screening the powder molding material according to JIS R-6002 (1978),

(2) plotting respective weight proportions of the powder molding material having passed through respective standard screens toward respective sizes of opening of respective standard screens, and

(3) obtaining an average particle diameter from an intersecting point between (i) a cumulative weight proportion line obtained from the above-mentioned respective plots, and (ii) a line having a cumulative weight proportion of 50% by weight.

A content of powder having a particle diameter of not more than 150 μm contained in the powder in the present invention is not more than 25% by weight, preferably not more than 22% by weight, and further preferably not more than 20% by weight, wherein a total of the powder is 100% by weight. When said content is more than 25% by weight, workability may be poor. Said content is measured by the same method as that mentioned above for measuring an average particle diameter.

A content of powder having a particle diameter of more than 600 μm contained in the powder molding material of the present invention is preferably not more than 5% by weight, and further preferably not more than 3% by weight in order to improve mechanical strength of the obtained powder molded article, wherein a total of the powder is 100% by weight. Said content is measured by the same method as that mentioned above for measuring an average particle diameter.

The powder molding material of the present invention can be applied to various powder molding methods such as a powder slush molding method, a fluidized dipping method, an electrostatic coating method, a powder flame spraying method and a powder rotational molding method. Among them, a powder slush molding method is preferable.

For example, a molded article according to a powder slush molding method is produced by a method comprising the steps of:

(1) supplying the powder molding material onto a mold area of a mold heated at temperature of not less than a fusion temperature of the polymer particle, wherein a mold temperature is generally from 160 to 320° C., and a mold is heated by a method such as a gas oven method, a heat transfer medium oil-recycling method, a dipping method in a heat transfer medium oil, a dipping method in a fluidized hot sand, and a high frequency induction heating method,

(2) melt-adhering the supplied powder molding material to each other, at least a surface of which material is fused, by heating the supplied powder molding material on said mold area for a predetermined time,

(3) recovering the powder molding powder, which has not been melt-adhered,

(4) further heating the mold mounted with the fused powder molding material (optional step), and

(5) cooling the mold, and releasing a molded article formed thereon from the mold.

In order to improve releasability mentioned in the step (5), it is permitted to coat a fluorine-based mold release agent or a silicon-based mold release agent on the mold area of the mold prior to heating the mold in the above-mentioned step (1). Examples of the fluorine-based mold release agent (spray) are DAIFREE GA-6010 (diluted by an organic solvent) and DAIFREE ME-413 (diluted by water), both manufactured by Daikin Industries, Ltd., and examples of the silicon-based mold release agent (spray) are KF96SP (diluted by an organic solvent) manufactured by Shin-Etsu Silicon Co., Ltd., and FREELEASE 800 (diluted by water) manufactured by NEOS Co., Ltd.

The powder molding material of the present invention is used for a mono-layer molded article, or for a multi-layer molded article, wherein other layer(s) is(are) laminated on one side or both sides of a molded article comprising the powder molding material. Examples of said other layer(s) are a synthetic resin layer and a metal layer. Examples of said synthetic resin are a polyolefin resin such as polypropylene and polyethylene, thermoplastic elastomer, a polyamide resin, an ethylene-vinyl alcohol copolymer, a polyester resin, ABS (acrylonitrile-butadiene-styrene copolymer) and an adhesive resin. These layers may be foamed layers.

A molded article comprising the powder molding material of the present invention can be used most suitably, for example, for automobile interior parts such as instrumental panels, door trims, console boxes and pillars.

### EXAMPLES

The present invention is explained with reference to the following Examples, which are not intended to limit the scope of the present invention.

Evaluation Methods

(1) Melt Flow Rate (MFR)

It was measured at 230° C. under a load of 21.18 N according to JIS K-7210 (1976).

(2) Content (T % by Weight) of a Vinyl Aromatic Compound Unit Contained in a Hydrogenated Vinyl Aromatic Compound-Conjugated Diene Copolymer

It was obtained according to a ¹H-NMR measuring method (frequency 90 MHz) using a carbon tetrachloride solution of a hydrogenated vinyl aromatic compound-conjugated diene copolymer.

(3) Content (S % by Weight) of a Vinyl Aromatic Compound Unit Contained in a Vinyl Aromatic Compound Polymer Block (a)

It was obtained according to a ¹H-NMR measuring method (frequency 90 MHz) using a carbon tetrachloride solution of a hydrogenated vinyl aromatic compound-conjugated diene copolymer.

(4) Content (V % by Weight) of a Hydrogenated Conjugated Diene Unit Having a Two or More Carbon Atom-Carrying Branched Chain

It was obtained according to a Morero method using an infrared analysis.

(5) Hydrogenation Proportion of a Hydrogenated Vinyl Aromatic Compound-Conjugated Diene Copolymer

It was obtained according to a ¹H-NMR measuring method (frequency 90 MHz) using a carbon tetrachloride solution of a vinyl aromatic compound-conjugated diene copolymer, and a carbon tetrachloride solution of a hydrogenated vinyl aromatic compound-conjugated diene copolymer.

(6) Glass Transition Temperature

It was measured according to JIS K-7121 (1987) using 10 mg of a thermoplastic resin and/or thermoplastic elastomer with a differential canning calorimeter, DSC RDC220, manufactured by Seiko Instruments Inc. A temperature range measured was from −150 to 100° C., and a heat-up rate was 5° C./minute.

(7) Average Particle Diameter of a Powder Molding Material

It was obtained according to JIS R-6002 (1978) using standard screens defined in JIS Z-8801 (1976), which screens had respective mesh values of 500 μm, 355 μm, 250 μm, 212 μm, 180 μm, 150 μm and 106 μm (inner diameter of 200 mm), by a method comprising the steps of:

(i) piling up the standard screens on a saucer in order of a smaller mesh value,

(ii) supplying 100 g of a powder molding material onto the uppermost standard screen (500 μm),

(iii) screening for 10 minutes at frequency of 165 Hz in an amplitude of vibration of 1.2 cm, using a screen vibrator manufactured by Iida Seisakujyo Co., Ltd.,

(iv) plotting values on coordinates, wherein respective sizes of opening of the standard screens are plotted on an X axis (unit: μm), and respective weight proportion values of the powder molding material having passed through respective standard screens are plotted on a Y axis (unit: % by weight), where a total amount of the material used for the measurement is 100% by weight,

(v) making a cumulative weight proportion line by connecting respective plots, and

(vi) obtaining an intersecting point of the cumulative weight proportion line with a line having a cumulative weight proportion of 50% by weight (namely, a line at a cumulative weight proportion of 50% by weight on the Y axis), and assigning a value on the X axis corresponding to the intersecting point to be an average particle diameter of the powder molding material.

(8) Content of Powder Having a Particle Diameter of not More than 150 μm Contained in a Powder Molding Material

After measuring the above-mentioned average particle diameter, a content (% by weight) of powder having passed through the 150 μm screen was obtained.

(9) Primary Particle Diameter of Inorganic Powder

It was obtained by a method comprising the steps of:

(i) observing inorganic powder with an electron microscopy of 2000 to 5000 magnifications,

(ii) measuring each diameter of 50 powder particles optionally selected, and

(iii) assigning a number average value thereof to be a primary particle diameter of inorganic powder.

(10) Workability of a Powder Molding Material

It was evaluated by a method comprising the steps of:

(i) putting 1 kg of a powder molding material produced according to a method mentioned hereinafter into a polyethylene-made transparent bag having a size of 26 cm×38 cm×0.03 mm (thickness) manufactured by Thermo Co., Ltd.,

(ii) allowing it to stand for one hour at room temperature,

(iii) discharging the powder molding material into the atmosphere with an opening of the bag turned downwards, and

(iv) observing floating behavior of the discharged powder molding material in the atmosphere, and evaluating according to criteria: a mark “×” when the floating behavior thereof was observed, and a mark “◯” when the floating behavior thereof was hardly observed.

(11) Powder Flowability of a Powder Molding Material

It was evaluated by a method comprising the steps of:

(i) putting 100 cm³ of the powder molding material into a funnel of a bulk density measurement apparatus mentioned in JIS K-6722 (1977),

(ii) opening a dumper to discharge the powder molding material, and

(iii) measuring a time from said opening point to a completely discharging point of the powder molding material.

(12) Melt Property of a Powder Molding Material

It was evaluated by a method comprising the steps of:

(i) scattering the powder molding material onto a nickel-made mold (15 cm×15 cm×3 mm thickness) heated at 290° C.,

(ii) after a lapse of 15 seconds from said scattering point, sweeping down an extra powder molding material non-adhered to the mold,

(iii) putting the adhered powder molding material-carrying mold into a gear oven having an atmospheric temperature of 290° C., and heating the mold for one minute,

(iv) cooling the mold, and then releasing a sheet-like powder molded article from the mold, and

(v) observing visually an existence of a pin hole formed on a surface of the powder molded article, said surface meaning that having been contacted with the mold, according to criteria: a mark “×” when a pin hole was observed thereon, and a mark “◯” when no pin hole was observed thereon.

### Example 1

(1) Production of a Thermoplastic Elastomer Pellet

The following starting materials were kneaded using a double screw kneader, TEX-44HCT, manufactured by The Japan Steel Works, Ltd., at cylinder temperature of 150° C. to obtain 80 g of a thermoplastic elastomer having a melt flow rate (MFR) of 80 g/10 min. The thermoplastic elastomer was cut with a cutter to obtain a pellet thereof. Incidentally, a glass transition temperature of the thermoplastic elastomer was −45° C.

Starting Materials

(i) As a polyolefin-based resin, 100 parts by weight of a propylene-ethylene random copolymer resin, PPD200, having an ethylene unit content of 5% by weight and an MFR of 220 g/10 min., manufactured by Sumitomo Chemical Co., Ltd.

(ii) As an ethylene-α-olefin copolymer, 84 parts by weight of an ethylene-1-octene copolymer, ENGAGE 8411, having an MFR of 18 g/10 min. measured at 190° C. under a load of 21.18 N, and an A hardness of 76, manufactured by Du Pont Dow Elastomers L.L.C.

(iii) As a hydrogenated vinyl aromatic compound-conjugated diene copolymer, 113 parts by weight of a hydrogenated styrene-butadiene-styrene block copolymer having \mathring{1} a total content of a styrene unit of 15% by weight, \mathring{2} a content of a vinyl aromatic compound unit contained in a vinyl aromatic compound polymer block of 100% by weight, \mathring{3} a content of a hydrogenated conjugated diene unit having a two or more carbon atom-carrying branched chain of 80% by weight, and \mathring{4} a hydrogenation proportion of a double bond contained in a conjugated diene unit of 98%.

(iv) As a hydrogenated terpene resin, 16 parts by weight of CLEARON M115 manufactured by Yasuhara Chemical Co., Ltd.

(v) As an antioxidant, 1.8 part by weight of IRGANOX 1076 manufactured by Ciba Specialty Chemicals K.K.

(vi) As a Lubricant, 0.6 part by weight of NEUTRON S (erucic amide) manufactured by Nippon Fine Chemical Co., Ltd.

(vii) As a pigment, 9 parts by weight of a gray color pigment, GRAY PPM8Y1853, manufactured by Sumika Color Co., Ltd.

(2) Production of a Powder Molding Material

The above-mentioned pellet was pulverized using a hummer mill, LINLEX MILL TYPE LX-0, manufactured by Hosokawa Micron Corporation to obtain a thermoplastic elastomer powder. An inner temperature of the mill measured with a thermocouple set at its outlet was −75° C., and its plate rotating speed was 11000 rpm.

Next, 100 parts by weight of the thermoplastic elastomer powder, 1.0 part by weight of silica, OX 50, having a primary particle diameter of 50 nm, manufactured by Nippon Aerosil Co., Ltd., and 2.0 parts by weight of alumina-silica, JC 30, having a primary particle diameter of 3 nm, manufactured by Mizusawa Industrial Chemicals, Co., Ltd. were dry blended at 1500 rpm for one minute using a Henschel mixer, 5 LITER SUPER MIXER, manufactured by Kawata Seisakusho Corporation to obtain a powder molding material. Evaluation results of an average particle diameter of the obtained powder molding material, a content of powder having a particle diameter of not more than 150 μm contained therein, its powder flowability, workability and melting property are shown in Table 1.

### Comparative Example 1

Example 1 was repeated except that the inner temperature of the mill was changed to −100° C. Evaluation results are shown in Table 1.

### Comparative Example 2

Example 1 was repeated except that the inner temperature of the mill was changed to −120° C. Evaluation results are shown in Table 1.

### Comparative Example 3

Example 1 was repeated except that the inner temperature of the mill was changed to −60° C. However, the pellet was melt-adhered with each other because of shear heating when pulverizing, and as a result, pulverization was impossible.

### Example 2

Example 1 was repeated except that the starting materials used in the production of a thermoplastic elastomer pellet were changed to the following starting materials. Evaluation results are shown in Table 2. Incidentally, a melt flow rate (MFR) of the obtained thermoplastic elastomer was 70 g/10 min., and a glass transition temperature thereof was −42° C.

Starting Materials

(i) As a polyolefin-based resin, 100 parts by weight of a propylene-ethylene random copolymer resin, PPD200, having an ethylene unit content of 5% by weight and an MFR of 220 g/10 min., manufactured by Sumitomo Chemical Co., Ltd.

(ii) As an ethylene-α-olefin copolymer, 104 parts by weight of an ethylene-1-butene copolymer, CX 5501, having an MFR of 30 g/10 min. measured at 190° C. under a load of 21.18 N, and an A hardness of 70, manufactured by Sumitomo Chemical Co., Ltd.

(iii) As a hydrogenated vinyl aromatic compound-conjugated diene copolymer, 156 parts by weight of a hydrogenated styrene-butadiene-styrene block copolymer having \mathring{1} a total content of a styrene unit of 15% by weight, \mathring{2} a content of a vinyl aromatic compound unit contained in a vinyl aromatic compound polymer block of 100% by weight, \mathring{3} a content of a hydrogenated conjugated diene unit having a two or more carbon atom-carrying branched chain of 80% by weight, and \mathring{4} a hydrogenation proportion of a double bond contained in a conjugated diene unit of 98%.

(iv) As a hydrogenated terpene resin, 19 parts by weight of CLEARON M135 manufactured by Yasuhara Chemical Co., Ltd.

(v) As an antioxidant, 2.2 parts by weight of IRGANOX 1076 manufactured by Ciba Specialty Chemicals K.K.

(vi) As a Lubricant, 0.7 part by weight of NEUTRON S (erucic amide) manufactured by Nippon Fine Chemical Co., Ltd.

(vii) As a pigment, 11 parts by weight of a gray color pigment, GRAY PPM8Y1853, manufactured by Sumika Color Co., Ltd.

### Comparative Example 4

Example 2 was repeated except that the inner temperature of the mill was changed to −100° C. Evaluation results are shown 10 in Table 2.

TABLE 1

| | Comparative | | |
|---|---|---|---|
| | Example | | |
| Example 1 | 1 | 2 | 3 |

Condition for pulverizing

| | | | | |
|---|---|---|---|---|
| Inner temperature of mill (° C.) | −75 | −100 | −120 | −60 |
| Properties of powder molding material | | | | |
| Average particle diameter (μm) | 263 | 193 | 150 | — |
| Content of powder having particle | 22 | 35 | 51 | — |
| diameter of not more | | | | |
| than 150 μm (wt %) | | | | |
| Evaluation of properties | | | | |
| Workability | ◯ | X | X | — |
| Powder flowability (second) | 15.8 | 18.8 | 26.4 | — |
| Melt property | ◯ | ◯ | ◯ | — |

TABLE 2

| | | Comparative |
|---|---|---|
| | Example 2 | Example 4 |
| Condition for pulverizing | | |
| Inner temperature of mill (° C.) | −75 | −100 |
| Properties of powder molding material | | |
| Average particle diameter (μm) | 220 | 192 |
| Content of powder having particle | 22 | 32 |
| diameter of not more than 150 μm (wt %) | | |
| Evaluation of properties | | |
| Workability | ◯ | X |
| Powder flowability (second) | 16.6 | 19.2 |
| Melt property | ◯ | ◯ |

1. A powder molding material comprising powder, which powder (1) contains a polymer particle, and (2) satisfies the following requirements (i) and (ii), wherein the polymer particle \mathring{1} comprises a thermoplastic resin and/or thermoplastic elastomer, and \mathring{2} has a melt flow rate of not less than 10 g/10 minutes measured at 230° C. under a load of 21.18 N according to JIS K-7210 (1976):
(i) the powder has an average particle diameter of from 200 to 350 μm, and
(i) a content of powder having a particle diameter of not more than 150 μm contained in the powder is not more than 25% by weight, wherein a total of the powder is 100% by weight.

2. The powder molding material according to claim 1, wherein the polymer particle contains the following components (1) to (3):
(1) a polyolefin-based resin,
(2) an ethylene-α-olefin copolymer satisfying the following requirement (iii):
(iii) an A hardness of the ethylene-α-olefin copolymer measured according to JIS K-6253 (1997) is not more than 80, and
(3) a hydrogenated vinyl aromatic compound-conjugated diene copolymer satisfying the following requirements (iv) and (vii):
(iv) the hydrogenated vinyl aromatic compound-conjugated diene copolymer comprises a hydrogenated vinyl aromatic compound-conjugated diene copolymer containing the following structural units (a) and (b):
(a) a vinyl aromatic compound polymer block, and
(b) at least one block selected from the group consisting of the following (b1) and (b2):
(b1) a vinyl aromatic compound-conjugated diene copolymer block, and
(b2) a conjugated diene polymer block,
(v) a content, T % by weight, of a vinyl aromatic compound unit contained in the hydrogenated vinyl aromatic compound-conjugated diene copolymer is from 10 to 18% by weight, wherein an amount of the hydrogenated vinyl aromatic compound-conjugated diene copolymer is 100% by weight,
(vi) a content, V % by weight, of a hydrogenated conjugated diene unit having a two or more carbon atom-carrying branched chain contained in the hydrogenated vinyl aromatic compound-conjugated diene copolymer is more than 60% by weight, wherein a content of a hydrogenated conjugated diene unit contained in the hydrogenated vinyl aromatic compound-conjugated diene copolymer is 100% by weight, and
(vii) a content, S % by weight, of a vinyl aromatic compound unit contained in the vinyl aromatic compound polymer block (a), T in the requirement (v) and V in the requirement (vi) satisfy the following formula (1):
V≦0.375×S+1.25×T+40 (1)
wherein a content of a vinyl aromatic compound unit contained in the hydrogenated vinyl aromatic compound-conjugated diene copolymer is 100% by weight.

3. The powder molding material according to claim 1, wherein the polymer particle contains a mechanically pulverized product of a pellet comprising a thermoplastic resin and/or thermoplastic elastomer.

4. The powder molding material according to claim 1, wherein the powder contains a dry blend comprising:
(1) 100 parts by weight of the polymer particle, and
(2) from 0.1 to 10 parts by weight of fine powder having a primary particle diameter of not more than 10 μm.

5. A process for producing a powder molding material mentioned in claim 1, which comprises the steps of:
(1) cooling a pellet containing a thermoplastic resin and/or thermoplastic elastomer at temperature of not higher than a glass transition temperature thereof, and
(2) pulverizing the cooled pellet in a mill having an inner temperature of from −72 to −88° C.

6. The process for producing a powder molding material according to claim 5, wherein the process comprises the following additional step (3) after the step (2):
(3) dry blending a pulverized product produced in the step (2) and fine powder in a mixer having a mixing and agitating blade, a starting material-feeding equipment and a product-discharging equipment.
